(19) United States
(12) Patent Application Publication
(10) Pub. No.: US 2020/0243942 A1
(43) Pub. Date: Jul. 30, 2020

(54) AUTOMOTIVE SATELLITE ANTENNA ASSEMBLY FOR UNDER-GLASS APPLICATIONS

(71) Applicant: Kathrein Automotive North America, Inc., Rochester Hills, MI (US)

(72) Inventors: Andreas D. Fuchs, Lake Orion, MI (US); Ehab M. AbdulRahman, Rochester Hills, MI (US); Ran Liu, Rochester Hills, MI (US)

(21) Appl. No.: 16/259,050

(22) Filed: Jan. 28, 2019

(51) Int. Cl. H01Q 1/12; H01Q 1/48; H01Q 1/32

(52) U.S. Cl. CPC H01Q 1/1271; H01Q 1/3275; H01Q 1/3233; H01Q 1/48

(57) ABSTRACT

The specification discloses an automotive satellite antenna assembly adapted for placement within an automotive vehicle passenger compartment under the vehicle glass, such as the windshield, the rear window, a panoramic roof, or a sunroof. The assembly includes a satellite antenna, a ground plane electrically connected to the antenna, and a choke ring electrically connected to the ground plane and defining a conductive cavity in which the antenna is located. The dimensions of the ground plane are smaller than the wavelength of any signal within the frequency range of the antenna. Preferably the antenna, the ground plane, and the choke ring have substantially the same shape and are concentric with one another.

### BACKGROUND

The present invention relates to antennas and more particularly to automotive satellite antennas mounted under glass.

Satellite antennas for automotive and other vehicles are well known and widely used. The growth of the autonomous driving market has raised the importance of high-definition global positioning systems (HD-GPS) on vehicles. Antennas and antenna systems play a significant role in achieving the desired accuracy.

Satellite antennas should have a good sky view, high cross polarization, low axial ratio, and upward gain pattern, all of which assist in filtering out reflection signals and boosting good line-of-sight signals. Typically, good performance can be achieved by using a large ground plane, such as the vehicle roof. The trend in the automotive antenna industry is to hide the antennas inside the car body or the passenger compartment. Specific locations include under the windshield, under the rear window, or under a panoramic roof or a sunroof, which enables the best sky view. Unfortunately, as radiating structures, antennas are not independent from their surrounding environment. Positioning the antenna under the glass undermines the antenna and deforms the antenna pattern, introducing unwanted back loop and decreasing cross polarization and axial ratio.

### SUMMARY

The present invention addresses the aforementioned problems by enabling a satellite antenna assembly having a small ground plane to achieve the desired performance when positioned under glass. Specifically, the antenna assembly includes a choke ring defining a conductive cavity within which the satellite antenna is positioned.

More specifically, the automotive satellite antenna assembly includes a satellite antenna, a ground plane to which the antenna is electrically connected, and a choke ring electrically connected to the ground plane. The satellite antenna is dimensioned to receive signals of defined frequency(ies), and the ground plane is dimensioned to be smaller than the wavelength of any defined frequency(ies). The choke ring defines a conductive cavity, and the satellite antenna is located within the conductive cavity.

The conductive cavity provided by the choke ring significantly corrects the glass effect and re-forms the beam in its proper shape, thereby reducing back loop and improving the cross polarization and the axial ratio. The conductive cavity compensates for performance degradation introduced by the vehicle glass and the relatively small ground plane.

These and other advantages and features of the invention will be more fully understood and appreciated by reference to the description of the current embodiment and the drawings.

### BRIEF DESCRIPTION OF THE DRAWINGS

FIG. 1 is a perspective view of an automotive vehicle including an automotive satellite antenna assembly in accordance with a first embodiment.

FIG. 2 is a perspective view of the antenna assembly.

FIG. 3 is a perspective view of the satellite antenna within the first embodiment.

FIG. 4 is a perspective view of an automotive satellite assembly in accordance with a second embodiment of the invention.

FIG. 5 is a perspective view of the satellite antenna within the second embodiment.

FIG. 6 is a graph showing the measurement result of the antenna performance improvement in the Right Hand Circular (RHC) cross polarization average gain pattern provided by the first embodiment at the center of the L5 frequency band (i.e. 1176 MHz).

FIG. 7 is a graph showing the measurement result of the antenna performance improvement in the Left Hand Circular (LHC) cross polarization average gain pattern provided by the first embodiment at the center of the L5 frequency band (i.e. 1176 MHz).

FIG. 8 is a graph showing the measurement result of the antenna performance improvement in the average axial ratio provided by the first embodiment at the center frequency of the L5 frequency band (i.e. 1176 MHz).

### DESCRIPTION OF THE CURRENT EMBODIMENTS

Before the embodiments of the invention are explained, it is to be understood that the invention is not limited to the details of operation or to the details of construction; and the arrangement of the components set forth in the following description or illustrated in the drawings. The invention may be implemented in various other embodiments and may be practiced or carried out in alternative ways not expressly disclosed herein.

In addition, it is to be understood that the phraseology and terminology used herein are for the purpose of description and should not be regarded as limiting. The use of “including” and “comprising” and variations thereof encompasses the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one or more of X, Y or Z individually, and any combination of any one or more of X, Y and Z, for example, X, Y, Z; X, Y; X, Z ; and Y, Z.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

### I. First Embodiment

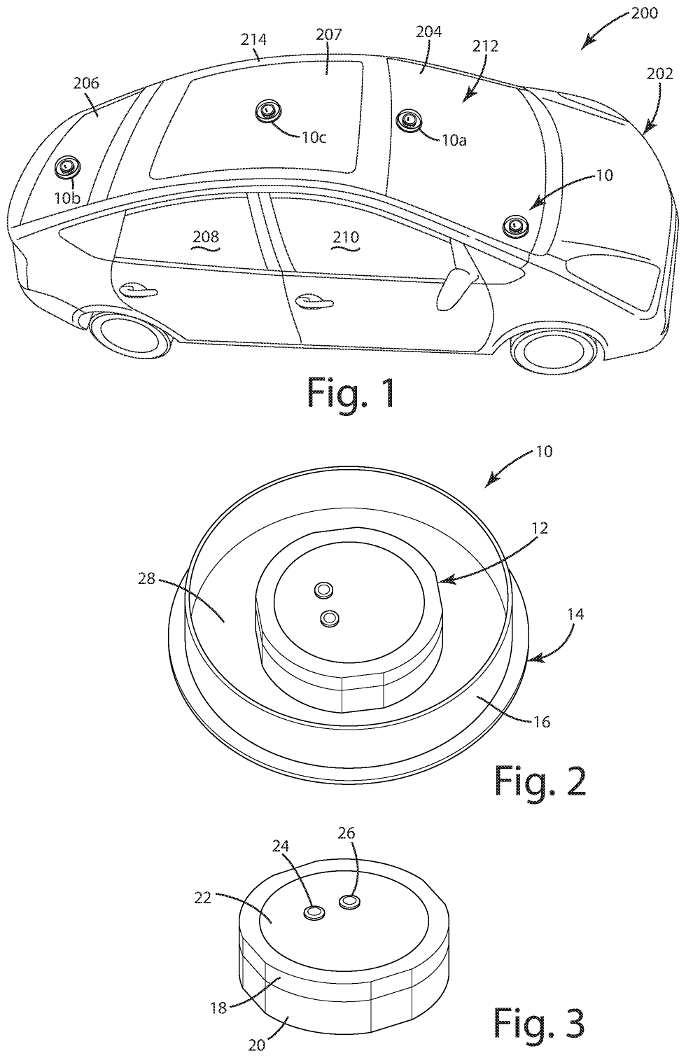

An automotive satellite antenna assembly constructed in accordance with a first embodiment of the invention is illustrated in FIGS. 1-2 and generally designated 10.

FIG. 1 illustrates the antenna assembly 10 mounted within a vehicle 200. The vehicle 200 includes a body 202 supporting a windshield 204, a rear window 206, a panoramic roof or sunroof 207, side windows 208 and 210, and additional glass that is not visible. The windshield, the rear window, the panoramic roof/sunroof, and the side windows may be collectively referred to as the vehicle glass. The glass may be of any type now known or later developed for use in automotive applications. The vehicle 200 includes a passenger compartment 212 which is at least partially enclosed by the vehicle glass. The antenna assembly 10 is mounted within the passenger compartment 212 and under the windshield 204. The antenna assembly may be mounted in other positions under the vehicle glass, such as 10a under the upper portion of the windshield 204, or 10b under the rear window 206, or 10c under the panoramic roof/sunroof.

As illustrated in FIG. 2, the satellite antenna assembly 10 includes a satellite antenna 12, a ground plane 14, and a choke ring 16. The antenna 12 and the ground plane 14 are generally known to those skilled in the art. The choke ring 16 and the resultant antenna assembly 10 are new in the present invention.

The antenna 12, as noted above, may be any automotive satellite antenna known to those skilled in the art. The disclosed antenna is a dual-pin, dual-band, GNSS (Global Navigation Satellite System) patch antenna. Alternatively, the antenna 10 may be any other type of satellite or sky view antenna. Examples include a single-pin, single-band, GNSS patch antenna, or an SDARS (Satellite Digital Audio Radio Services) antenna (e.g. Sirius and XM radio).

The antenna 12 (see FIGS. 2-3) is a directional antenna, and as disclosed a patch antenna 22, that includes a dielectric layer 18, which may be a ceramic, a Teflon, or any other suitable material. The structure could also support a multi-band stacked patch that is ceramic loaded. Antenna 12 further includes a top conductive patch 22 and a middle conductive patch (not visible) between the dielectric layers 18 and 20. The antenna 12 additionally includes feed pins 24 and 26 electrically connected to both of the patches.

The top patch 22 is tuned to the L1 frequency of 1.575 GHz, having a wavelength of 19.05 centimeters (cm). The middle patch is tuned to the L5 frequency of L176 GHz, having a wavelength of 25.48 cm. As will be apparent to those skilled in the art, the patches may be tuned to any desired frequency or any desired frequency range. Additionally, a greater or fewer number of patches may be provided.

The antenna 12 is generally circular in shape and has a diameter of approximately 42 millimeters (mm) and a height of approximately 12.5 mm. As will be apparent to those skilled in the art, the shape and the size of the antenna 12 may be selected to achieve desired results.

The ground plane 14, again as noted above, may be fabricated of any electrically conductive material. In the current embodiment, the ground plane is circular. As will be apparent to those skilled in the art, the shape of the ground plane and the size of the ground plane may be selected to achieve desired results. The antenna 10 is electrically connected to the ground plane by way of the feed pins 24 and 26.

The ground plane 14 has a diameter of approximately 80 mm. The diameter, or any other dimension, of the ground plane 14 is less than the longest wavelength of the defined frequency or frequencies (i.e. the frequency range) for which the antenna 12 is tuned. In the present invention, the diameter of the ground plane 14 is approximately one-third of the longest wavelength.

The choke ring or conductive shield 16 may be fabricated of any electrically conductive material. The choke ring 16 is electrically connected to the ground plane 14 and has a diameter of approximately 73 mm. Consequently, the choke ring 16 is somewhat smaller in diameter than the ground plane 14. The size can be tuned to achieve desired results. The choke ring defines an interior or conductive cavity 28 above the ground plane 14. The height of the choke ring 16 is approximately 14 mm. Consequently, the antenna 12 is located entirely within the conductive cavity 28. The choke ring 16 may be continuous and uninterrupted through its perimeter (as illustrated). Alternatively, the choke ring may be segmented about its perimeter.

The antenna 12, the ground plane 14, and the choke ring 16 all are substantially circular and all are oriented concentrically with respect to one another. Again, different shapes and or relative positions may be selected to achieve desired results.

### II. Second Embodiment

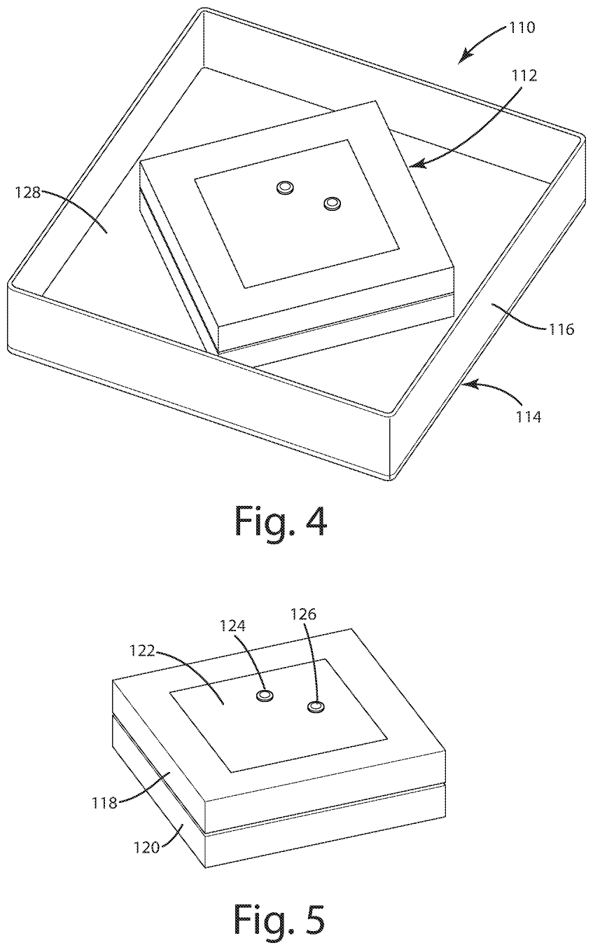

An alternative embodiment 110 of the antenna assembly is illustrated in FIG. 4. The designating numbers in FIGS. 4-5 correspond to the designating numbers and FIGS. 2-3 with the addition of 100 (e.g. 10 in FIGS. 2-3 becomes 110 in FIGS. 4-5).

The primary difference between the antenna assembly 110 and the antenna assembly 10 is that the components of the antenna assembly 110 are substantially square rather than substantially circular. The antenna 112 is 46 mm square and 13.5 mm high. Both the ground plane 114 and the choke ring 116 are 80 mm square and 14 mm high.

The antenna 112, the ground plane 114, and the choke ring 116 are concentric in the sense that they have a common center. As seen in FIG. 4, the antenna 112 is rotationally or angularly offset by 45° with respect to the ground plane 114 and the choke ring 116. The choke ring 116 can be rotated to any desired angle with respect to the antenna 112.

The antenna assemblies 10 and 110 illustrate that the shape and the size of the antenna components may be varied and yet remain within the scope of the present invention. Additionally, other shapes and/or sizes are possible and indeed expected as will be recognized by those skilled in the art. In particular, the antennas 12, 112 and the choke rings 16, 116 may have other shapes and/or sizes to achieve desired results.

### III. Performance

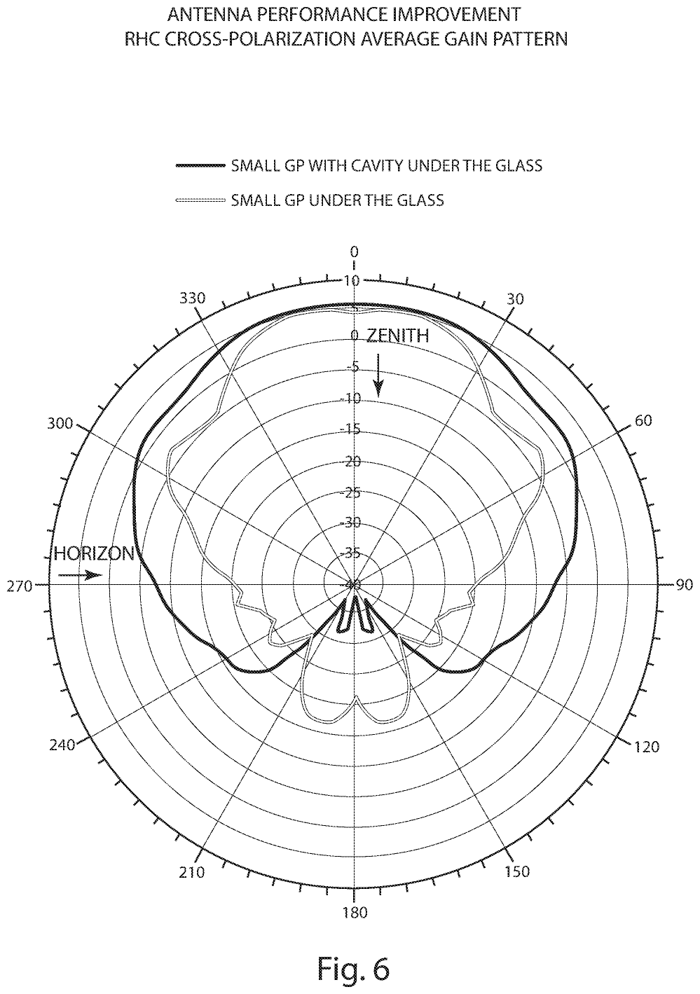

FIGS. 6-8 illustrate the far-field measurement results showing the improved performance of the antenna assembly 10 when positioned under glass. The black line in each graph illustrates the performance of the antenna assembly 10; and the gray line in each graph illustrates the performance of the antenna assembly if the choke ring 16 were note included.

FIG. 6 illustrates the antenna performance improvement in the RHC polarization average gain pattern.

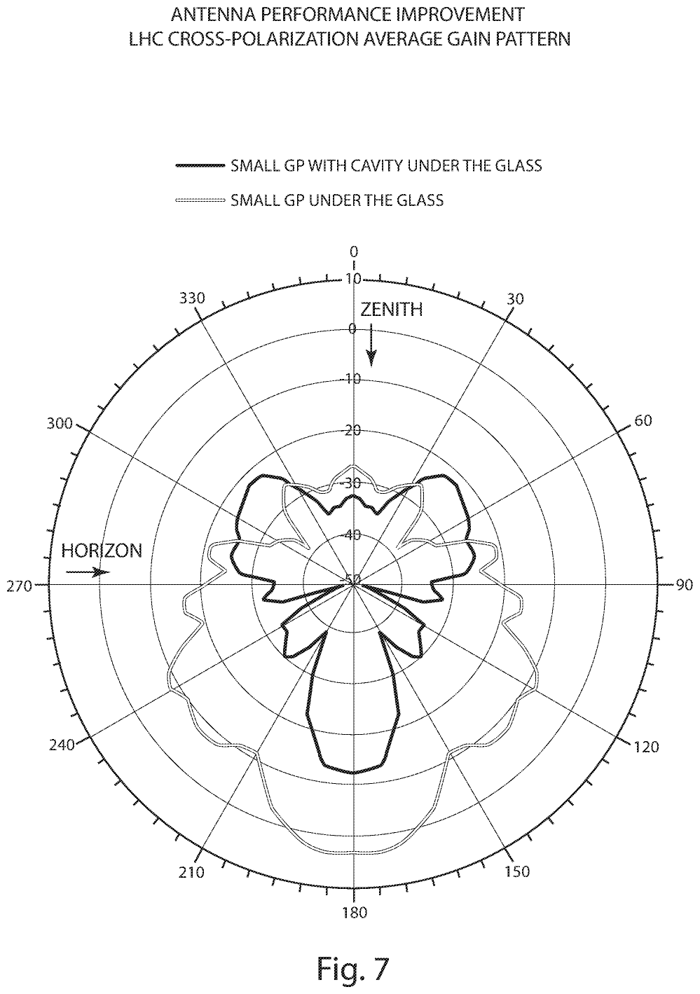

FIG. 7 illustrates the antenna performance improvement in the LHC cross polarization average gain pattern.

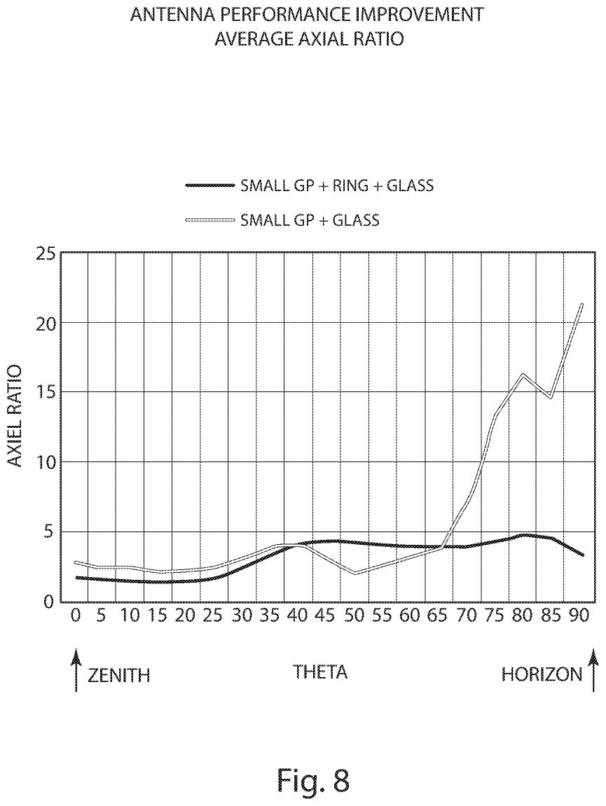

FIG. 8 illustrates the antenna performance improvement in the average axial ratio.

A higher choke ring 16, 116, and therefore a higher conductive cavity 28, 128, provides better axial ratio and cross polarization for both of the L1 and L5 bands. Preferably the choke ring 16 is designed also to also push the gain pattern to the sides, which provides improved balance of the radiation pattern over the upper hemisphere.

As seen in FIG. 6-8, the present invention (a) improves the performance of the antenna 12 in terms of radiation pattern distribution in the upper hemisphere, (b) improves the efficiency for the upper hemisphere, (c) improves the cross polarization and axial ratio, and (d) minimizes unwanted back loop and side loops.

### IV. Conclusion

The above descriptions are those of current embodiments of the invention. Various alterations and changes can be made without departing from the spirit and broader aspects of the invention as defined in the appended claims, which are to be interpreted in accordance with the principles of patent law including the doctrine of equivalents.

This disclosure is illustrative and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as alternatives.

Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. An automotive satellite antenna assembly for placement under a glass portion of an automotive vehicle, the automotive satellite antenna assembly comprising:
a satellite antenna adapted to receive signals within a defined frequency range;
a ground plane electrically connected to the satellite antenna, all dimension of the ground plane being smaller than the wavelength of any signal within the defined frequency range; and
a choke ring electrically connected to the ground plane, the choke ring defining a conductive cavity, the satellite antenna located within the conductive cavity.

2. An automotive satellite antenna assembly as defined in claim 1 wherein the satellite antenna, the ground plane, and the choke ring are substantially concentric with one another.

3. An automotive satellite antenna assembly as defined in claim 2 wherein dimensions of the choke ring are smaller than the dimensions of the ground plane.

4. An automotive satellite antenna assembly as defined in claim 1 wherein the antenna, the ground plane, and the choke ring are substantially circular.

5. An automotive satellite antenna assembly as defined in claim 1 wherein the antenna, the ground plane, and the choke ring are substantially square.

6. An automotive satellite antenna assembly as defined in claim 1 wherein the dimensions of the ground plane are less than the longest wavelength within the operating frequency of the satellite antenna.

7. An automotive satellite antenna assembly as defined in claim 1 wherein the satellite antenna is a directional antenna.

8. An automotive satellite antenna assembly as defined in claim 1 wherein the satellite antenna is entirely within the conductive cavity.

9. An automotive satellite antenna assembly as defined in claim 1 wherein the choke ring is continuous and uninterrupted throughout its perimeter.

10. An automotive satellite antenna assembly as defined in claim 1 wherein the choke ring is segmented about its perimeter.

11. An automotive vehicle assembly comprising:
an automotive vehicle having a passenger compartment and a glass panel at least partially defining the passenger compartment; and
an antenna assembly within the passenger compartment and visible from the outside the vehicle through the glass panel, the antenna assembly comprising:
a satellite antenna adapted to receive signals within a defined frequency range;
a ground plane electrically connected to the satellite antenna, all dimension of the ground plane being smaller than the wavelength of any signal within the defined frequency range; and
a choke ring electrically connected to the ground plane, the choke ring defining a conductive cavity, the satellite antenna located within the conductive cavity.

12. An automotive vehicle assembly as defined in claim 11 wherein the satellite antenna, the ground plane, and the choke ring are substantially concentric with one another.

13. An automotive vehicle assembly as defined in claim 11 wherein dimensions of the choke ring are smaller than the dimensions of the ground plane.

14. An automotive vehicle assembly as defined in claim 11 wherein the antenna, the ground plane, and the choke ring are substantially circular.

15. An automotive vehicle assembly as defined in claim 11 wherein the antenna, the ground plane, and the choke ring are substantially square.

16. An automotive vehicle assembly as defined in claim 11 wherein the satellite antenna is a directional antenna.

17. An automotive vehicle assembly as defined in claim 11 wherein the satellite antenna is entirely within the conductive cavity.

18. An automotive vehicle assembly as defined in claim 11 wherein the choke ring is continuous and uninterrupted throughout its perimeter.
